(19) United States
(12) Patent Application Publication
(10) Pub. No.: US 2020/0055524 A1
(43) Pub. Date: Feb. 20, 2020

(54) SYSTEM AND METHOD FOR VERIFYING THAT A SELF-DRIVING VEHICLE FOLLOWS TRAFFIC ORDINANCES

(71) Applicants: Alberto Lacaze, Gaithersburg, MD (US); Karl Murphy, Gaithersburg, MD (US); Joseph Putney, Gaithersburg, MD (US); Paige Junghans, Gaithersburg, MD (US); Rashmi Patel, Gaithersburg, MD (US)

(72) Inventors: Alberto Lacaze, Gaithersburg, MD (US); Karl Murphy, Gaithersburg, MD (US); Joseph Putney, Gaithersburg, MD (US); Paige Junghans, Gaithersburg, MD (US); Rashmi Patel, Gaithersburg, MD (US)

(21) Appl. No.: 16/105,801

(22) Filed: Aug. 20, 2018

(51) Int. Cl. B60W 50/04; G05D 1/00; G06K 9/00; G07C 5/00

(52) U.S. Cl. CPC B60W 50/045; G05D 1/0088; G06K 9/00818; G05D 2201/0213; G07C 5/008; B60W 2550/22; G06K 9/00825

(57) ABSTRACT

The system and method for verifying that a self-driving vehicle follows traffic ordinances disclosed herein may comprise, at least, a communication protocol between the system and the autonomous vehicle, a module for processing such communications and mapping them into vehicle safety analyses, a database of historical reports related to the vehicle, and a module for generating vehicle safety reports and alerts. Self-driving vehicles will need to be tested when they are first introduced, as well as on a continuing basis in order to verify that the system and sensors have not degraded to a point where the vehicle no longer complies with safety regulations. The presented invention assesses the safety of a self-driving vehicle and its autonomous system by evaluating the activities of the system against known or expected reactions and behaviors.

### TECHNICAL FIELD OF THE INVENTION

The present invention relates in general to autonomous vehicles, and, more specifically, to a system and method for verifying that a self-driving vehicle follows traffic ordinances.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Self-driving vehicles have become a reality, and commercial deployment of these systems will soon become commonplace. However, methods to verify the safety of these vehicles are still needed. Although assessing self-driving vehicles is new, assessing the safety of human drivers is not. Most countries have an established set of examinations that test the skills needed by a human to drive on public roads. These skills are assessed in a variety of ways; written tests, driving simulators, and closed or open circuit driving tests. In the end, they determine if the human can follow the rules of the road and drive safely. Similarly, test methods are needed to assess the self-driving vehicle's ability to follow current rules as well as future rules developed specifically for self-driving vehicles.

For self-driving vehicles, state and local municipalities need to verify their capability and safety. This testing needs to occur before allowing the vehicles on the road, and periodically afterwards as the vehicle and its sensors age. These tests may change depending on the age of the system. For example, some municipalities require that the skills of the elderly are assessed more frequently, or using different tests. Although we may assume that machines, unlike humans, are impervious to time, this not true. For example, some state-of-the-art laser detection and ranging (LADAR) systems have a useful life of only two years. System lifespan depends not only on how vigorously they have been used, but under what weather and temperature conditions they have been subjected. Therefore, the safety of the vehicles that rely on these sensors will change as the hardware ages. Self-driving vehicles will need to be tested when they are first introduced, as well as on a continuing basis in order to verify that the system and sensors have not degraded to a point where the vehicle no longer complies with safety regulations.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a system and method for verifying that a self-driving vehicle follows traffic ordinances.

It is an objective of the present invention to provide a self-driving vehicle verification system that may comprise a communication protocol between the system and the autonomous vehicle.

It is another objective of the present invention to provide a self-driving vehicle verification system that may comprise a module for processing such communications and mapping them into vehicle safety analyses.

It is another objective of the present invention to provide a self-driving vehicle verification system that may comprise a database of historical reports related to the vehicle.

It is another objective of the present invention to provide a self-driving vehicle verification system that may comprise a module for generating vehicle safety reports and alerts.

It is another objective of the present invention to provide a self-driving vehicle verification system that may determine an initial capability of an individual autonomous system.

It is another objective of the present invention to provide a self-driving vehicle verification system that may determine a current capability of an individual autonomous system.

It is another objective of the present invention to provide a self-driving vehicle verification system that may store a plurality of capability reports of an individual autonomous system.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 shows a plurality of traffic road signs commonly used in the United States, as must be recognized by the present invention.

FIG. 2 schematically presents a computing system configured to carry out and actualize methods and tasks described herein, in accordance with aspects of the present disclosure.

FIG. 3 illustrates a function map analyzing a self-driving vehicle, as contemplated by the present invention.

FIG. 4 illustrates a function map analyzing a self-driving vehicle, as contemplated by the present invention.

FIG. 5 illustrates an function map analyzing a self-driving vehicle over time, as contemplated by the present invention.

FIG. 6 schematically presents a system and method for verifying that a self-driving vehicle follows traffic ordinances, as contemplated by the present invention.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention provides a system and method for assessing the functional abilities of a self-driving vehicle and its autonomous system over the life of the vehicle. A self-driving vehicle comprises several components, namely the vehicle itself and the autonomous system. The vehicle itself may comprise any combination of automobile components, though most relevant to the invention are its powertrain, suspension, and braking subsystems. The autonomous system controls these various subsystems via actuation means that may accelerate, turn, and brake the vehicle under its direction. To determine the appropriateness of such controls, the autonomous system further comprises a plurality of sensors that allow for detection of the surrounding area and the present state of the vehicle. In many embodiments the autonomous system further comprises a database of route maps and known traffic rules and behaviors acceptable to its operating environment.

To assess the functional abilities of a self-driving vehicle and its autonomous system, the present system and method comprises, at least, a communication protocol between the system and the autonomous vehicle, a module for processing such communications and mapping them into vehicle safety analyses, a database of historical reports related to the vehicle, and a module for generating vehicle safety reports and alerts. The communication protocol may relate information about the vehicle's motion, responses to commands, sensor inputs, road conditions, and environmental conditions to the system, and the system itself may analyze and evaluate such communications against expected performance, past performance, minimum required performance, and predicted future performance of the vehicle and its autonomous system.

The data used to assess the functional abilities of a self-driving vehicle and its autonomous system can come from multiple sources: the output commands from the autonomous system; the output of the human driver, if present, the raw sensor data from the autonomous system, the internal computations of the autonomous system, the auxiliary sensors mounted on the self-driving vehicle for the purpose of the evaluation, and the ground truth data from the test site. Such ground truth data may comprise the locations of signs, lanes, vehicles, pedestrians, and other objects.

Fundamental to the need for the present system is the principal that all systems reduce in effectiveness as they age as a result of normal wear and tear, damage, and other breakdowns. Such systems of concern to an autonomous vehicle include laser detection and ranging (LADAR), radio detection and ranging (RADAR), and various cameras. By way of example, it is known that the light output of a laser diode diminishes with time. After three years of operation, this light output could be half of the original output. The coatings of lenses and protective covers can become scratched and less transparent over time, which lowers the transmissivity and, therefore, the effective range of the sensors. Cameras and laser detectors can “burn in” over time, especially after exposure to bright lights or the sun, decreasing their sensitivity and creating more noise. As with humans, these changes in performance are not usually dramatic or immediate, but instead occur gradually and slowly degrading the performance of the autonomous system. To what degree this degradation is occurring depends on many testable factors.

For example, a new LADAR may be able to detect a person wearing a black velour suit from 50 meters away, while the same LADAR, after several years of operation, may not. If a vehicle operation rule requires that a vehicle stay 50 m away from pedestrians, the aged LADAR will no longer be able to facilitate compliance with that rule. Such aging may be expected over the lifespan of known systems, though may also occur unexpectedly as a result of manufacturing variations or unforeseen circumstances. Some laser manufacturers use coatings that hold up to environmental conditions better than others, and exposure to environmental conditions may vary dramatically in different parts of the world. Testing the performance of the autonomous system over its life is an effective way of understanding and validating its current capabilities.

Of further concern, vehicles themselves suffer from deformation and breakdown over their lifespans as internal components wear and become loose and inaccurate. Other inaccuracies may also be caused by accelerations and vibrations to which the vehicle has been subjected, and the quality of the assembly process and engineering. Some sensor systems can self-calibrate while others cannot, and some can only calibrate certain parameters.

The present invention can be used to quantify the degradation of various sensors and subsystems, as the degree of degradation will affect performance of the self-driving vehicle and causing its infringement upon the rules of the road. An uncalibrated LADAR may blur the detection of a human crossing 60 meters away. If the rules of the road dictate that a vehicle leave a safety range of 65 meters, sooner or later the self-driving vehicle will infringe on that rule. Even before this infringement occurs, the invention will be able to detect that some obstacles are sensed at distances that are lower than the prescribed safety threshold and can alert to such a deficiency.

The invention has multiple use cases. In a first, the autonomous system is compared with a human driver over a period of time. In this case, the human drives the vehicle while the autonomous system is running in the background. The human has control of the steering, brake, and acceleration, and the output of the autonomous system is not connected but is recorded. The result of the human driver's actions, and the actions that the autonomous system would have taken, is post-processed and compared. Large differences between the two can be independently assessed, determining whether the autonomous system or the human behaved more safely and in compliance with road and traffic regulations. By way of example, a human-driven vehicle may stop at an intersection with another vehicle approaching from the right, and the human decides to cross the road in front of the other vehicle. The autonomous system, instead, decides to wait until the other vehicle passes. There may be a few reasons for the different outcomes: the human is driving too aggressively, the autonomous system is too conservative, or both responses are reasonable. These edge cases can be automatically selected and flagged for further assessment.

The second use case utilizes all of the rules applicable to a particular jurisdiction where the self-driving vehicle is operating. In the U.S. state of Maryland, for example, it is legal to make a right turn on a red light, provided that the vehicle makes a complete stop. To address this concern, the proposed invention computes and records the position of the self-driving vehicle and the location of other vehicles, their speed, and direction of travel. With the use of a known road network, the method verifies that all the prerequisites for a specific traffic rule are met.

For self-driving vehicles, the detection of other vehicles, pedestrians, and obstacles is one of the autonomous system's most important tasks. The distance from these other items when a detection is first made is an indication of the overall health of the sensing side of the autonomous system.

Additionally, a self-driving vehicle needs to predict the future location of the moving objects in its surroundings. Typically, the prediction is probabilistic, for example, a 75% chance that a vehicle may continue straight or a 25% chance that it will turn right. The presented invention can record the predictions at each time-step for later analysis. During post-processing the track that the other vehicle eventually follows would be known and compared with each prediction. The comparison of the prediction with the subsequent motion of the other vehicle provides a measure of the accuracy of the prediction and, therefore, an assessment of the safety of the vehicle.

The sensing information of the autonomous system, the distances, classification qualities, and changes of classification, can be used as a determination of the state of the sensors and the processing. As another example, if another vehicle is first detected at 50 meters, and the applicable rule requires a 55 meter safety distance, the detection is not sufficient even though the self-driving vehicle may not have broken the rule given its actions. The same is true for misclassifications. If a pedestrian 60 meters away is labeled as “vegetation,” and the classification changes from vegetation to pedestrian as the vehicle approaches, such errors present a clue that the sensors are not performing their task as efficiently as they should with respect to the rules of the road.

The present invention may be implemented in a number of ways. First, when a self-driving vehicle is first introduced to a locality, the invention will be used while a qualified human is on board, either as a driver or as an emergency operator. The invention will record internals of the sensing, classification, and actuation of the autonomous system as the self-driving vehicle performs a test scenario. A test scenario could be similar to a closed-circuit test course, or it can be a civilian roadway, given that the autonomous system being tested has a qualified emergency stop mechanism that satisfies the requirement of the law. During this testing period, the invention will then post-process the sensed information and ground truth, if available, and compare the behavior of the autonomous system against each one of the rules of the road of that particular locale. The invention will then automatically generate a report showing each of the infractions where the rules of the road were not followed, or could not have been followed given the detection distances and system limitations. In the case where the human driver is used, the invention will automatically flag the edge cases where the human behavior deviates significantly from the robotic behavior. These comparisons will also be checked against the rules of the road.

Second, the invention may be implemented as a periodic safety check procedure. The invention will provide a list of infractions where the self-driving vehicle has broken the rules of the road. The second maintenance inspection will also be used to gauge the deterioration of the sensing and predication modalities. In particular, detection distances, predication accuracies, and classification accuracies will be measured and compared against the rules of the road. Since most self-driving vehicles have redundant measurements for the above values, discrepancies between these redundant sensors will also be recorded and reported.

The invention further comprises a database with the rules of the road pertinent to a particular locale. In general, there are 40 to 60 rules that govern safe operation in each locality. Other rules are still necessary and but may not be explicit. For example, if the vehicle takes 30 seconds to start moving when a light turns green, it will cause discontent for other drivers, though it is not breaking any rules for most localities. The existence of these rules is specifically designed to minimize accidents and, to a certain degree, minimize communication between the users. On a two-way, two-lane road in the United States, the drivers will drive in the right-hand lane for each direction. Both drivers, going in opposite directions, do not need to signal to one another which lane they will use as the rule of the road defines the behavior. Different countries or different locales may have rules that are opposite such as, in England, under the exact same circumstances, it will be understood that the drivers will drive in the left lane. Understanding the rules and the locale to which they apply is not only important, but mandatory for safe interaction between drivers.

The invention will also determine if the self-driving vehicle is correctly detecting and following traffic control signals. These include, but are not limited to, Solid Red Light, Red Arrow Light, Flashing Red Light, Solid Yellow Light, Yellow Arrow Light, Flashing Yellow Light, Flashing Yellow Arrow Light, Green Light, Green Arrow Light, and Traffic Signal Lights not working. The behavior of the self-driving vehicle under each of these signals needs to be examined and verified for correctness. After the invention determines that the self-driving vehicle is in the lane corresponding to the particular signal, it will have to verify that the signal reported by the self-driving vehicle matches the ground truth. This verification is performed by the invention, either by sensing the signal with its own cameras and processing the images, or by using ground truth provided by the test course. The invention will then compare if the traffic signal sensed and reported by the self-driving vehicle matches the ground truth. Detection distances and accuracies are compared against ground truth.

After it is determined that the signal was correctly detected and at a reasonable distance to allow the self-driving vehicle to drive the speed limit and stop before the switch, then the invention checks if the signal is actually followed. The invention also checks if the behavior is correct when the lights are malfunctioning or turned off. In this case, the local regulations usually require that the autonomous system assumes that the intersection is a four way stop. Therefore, the self-driving vehicle must follow precedence rules.

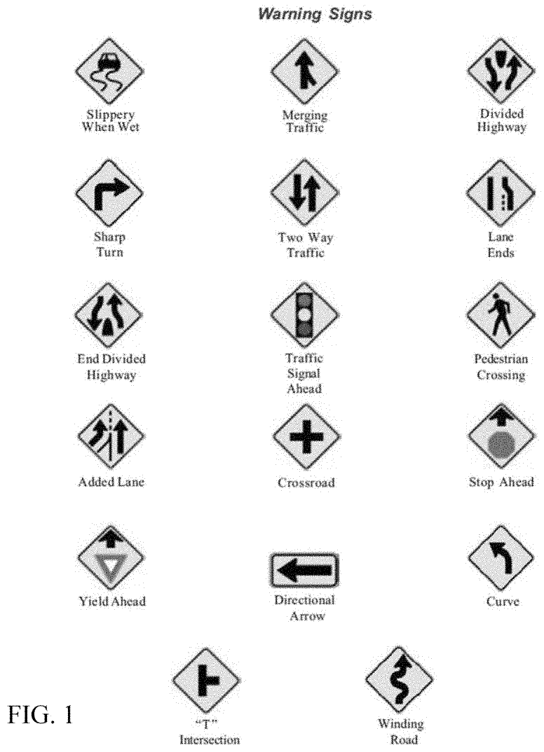

The invention also verifies if the autonomous system understands traffic signs. Specifically, the invention checks for stop signs, yield signs, “do not enter” signs, “wrong way” signs, “no u-turn” signs, railroad signs, pedestrian walkway signs, animal crossing signs, and any other commonly used road signs at that locale. Once again, the invention will get ground truth for a test course, and compare the detections provided by the autonomous system against the built-in data to verify that the signals have been detected correctly, and at which distances they have been detected. Once the correct detection has been verified, the invention then verifies that the behavior marked by the sign was actually followed. For example, if there is a wrong way sign, the autonomous system should not attempt to drive in those lanes. Most locales will require that self-driving vehicles are safe even if the infrastructure is down, and it is likely that there will be requirements for the self-driving vehicles to follow the signs even if the infrastructure is down. The illustration of FIG. 1 shows a plurality of traffic road signs commonly used in the United States.

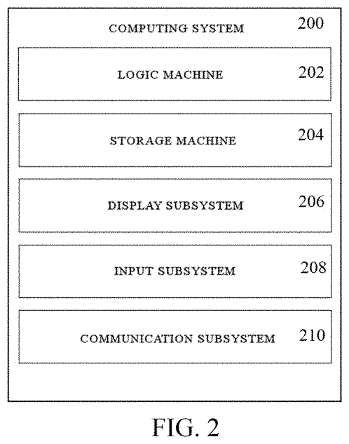

The illustration of FIG. 2 schematically presents a computing system that may represent an embodiment of the present invention. In some embodiments the method is executed on a computing system such as computing system 200 of FIG. 2. For example, storage machine 204 may hold instructions executable by logic machine 202 to provide the method to users. Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above. The described method may be executed, provided or implemented to a user on one or more computing devices via a computer-program product such as via an application programming interface (API). FIG. 2 schematically shows a non-limiting exemplary embodiment of a computing system 200 that can enact the method described above. Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210. Logic machine 202 may execute machine-readable instructions via one or more physical devices. For example, the logic machine 202 may be configured to execute instructions to perform tasks for a computer program. The logic machine may include one or more processors to execute machine-readable instructions. Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices. Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

The invention will also check to ensure that a self-driving vehicle complies with right-of-way rules, speed limits, lane control, turn signals, and passing rules.

Crosswalks: The invention verifies that the autonomous system yields to pedestrians in crosswalks. In particular, it verifies that the crosswalk is detected at a sufficient distance to stop, that the pedestrian at the crosswalk is detected with sufficient distance to stop, that the pedestrian has right of way, that the self-driving vehicle stops when the pedestrian has the right of way, and that the vehicle does not stop when the pedestrian does not have the right of way. It also verifies that there is a sufficient safety buffer that is maintained around the pedestrian, the stopping of the self-driving vehicle is not abrupt, the vehicle follows the demarcation lines, and it stops without encroaching into the pedestrian walkway areas. “Sufficient distance” is defined differently depending on the locality.

Intersections: The invention verifies that the intersection rules are followed. Even if there is no “STOP” or “YIELD” sign, the self-driving vehicle must detect the signs, or lack thereof, and follow the requirements. In particular, yield and precedence rules are verified both for other vehicles and pedestrians. At a “T” intersection without a stop or yield sign, pedestrians have the right of way. If this is a 4-way intersection, some locales give precedence to crossing pedestrians, while others do not. Some locales give precedence to vehicles coming from the right, while others do not. The invention is aware of the different rules for the different locales, and can make a determination on whether the local ordinances are followed. The invention will also verify that the self-driving vehicle is applying the correct turning signals at the correct distances. Some locales prescribe that the signals must be turned on at a certain distance or time from the intended turn.

Roundabouts: The invention verifies if the self-driving vehicle slows down before entering a roundabout. Many locales require this slow down even if no signs are posted. The invention verifies that the autonomous system finds all pedestrian walkways with sufficient distance to stop, and that it detects pedestrians in these walkways with sufficient time to stop. Finally, the invention verifies that the self-driving vehicle is in the outer lane before turning, and not in the outer lane if continuing within the circle. In many roundabouts, these rules are changed by using road markings. The invention will verify that these road markings are followed. The invention will also verify that the turning signals are applied at the correct time. Turning signals in a roundabout must comply with local regulations. Some regulations state that the signal needs to be turned on at a certain distance, unless there is another turn in the same direction within that distance. The invention takes the local rules into consideration and verifies that the correct logic is followed. The invention also verifies that the direction of travel is correct, given the local rules.

Mountain Roads: Many locales have special rules for mountain roads. For example, on a narrow mountain road, a vehicle going downhill must yield to a vehicle going uphill. The vehicle going downhill must back up until there is enough space to where the vehicle going uphill can pass. The invention will verify that the autonomous system can make the determination of what vehicle is going uphill, and what vehicle is going downhill; that the right of way is obeyed, and that the autonomous system safely backs up to provide right of way to the oncoming car. Similarly, if the self-driving vehicle is going uphill, and therefore has right of way, the self-driving vehicle must allow time for the downhill vehicle to move out of the way.

Maximum Speed Limit: The invention will verify that the self-driving vehicle does not exceed the speed limit either by going over the maximum or under the minimum. Some localities have signs indicating the maximum speed limits, while others have an inherent speed limit that is assigned by the road type.

Reduced Speeds: Some localities have weather-related rules, for example, maximum speed is 35 mph when fog is present. Condition of the road, work being performed, pedestrians present, school buses, and other factors are also incorporated into the rules. The invention uses these rules to verify if the rules have been met.

Heavy Traffic or Bad Weather: The invention takes into consideration heavy traffic or bad weather to determine if the speed is appropriate, according to the rules of the locality.

Towing Vehicles, Buses, or Large Trucks: The invention takes into consideration if the self-driving vehicle is towing a trailer that may have a different inherent maximum speed. The same is true if the autonomy is installed on a bus or large truck, which may be subject to different regulations.

Around Children: Many localities have special rules related to children, child zones, and school buses. The invention verifies that rules related to these special conditions are met. For example, the U.S. state of California stipulates that when driving within 500 and 1000 ft from children, the speed limit is capped at 25 mph. This rule requires that an autonomous system allowed to drive in California must be able to recognize and classify a pedestrian child at 1000 ft, or otherwise always drive at less than 25 mph, or be in a restricted road where children are not expected to walk.

Blind Intersection: The invention checks that the speed limit in blind intersections is followed. The autonomous system must recognize that this is a blind intersection, and slow down for the intersection. California requires that the vehicle slows down within 100 ft from the intersection, and that the vehicle must drive at less than 15 mph.

Alleys: Many localities have special rules for alleys or tight roadways. Some of the rules being verified by the invention include the maximum speeds in the alleys. For example, California restricts the speed on alleys to 15 mph.

Near Railroad Tracks: Many localities set specific speed limits near roadways. The invention checks if these rules are met. The vehicle usually must drive at a particular speed (<15 mph) within a zone (100 ft) if no signals are available. These rules also require that the vehicle detect trains, and that the vehicles maintain certain separations from trains within a safety zone, unless those trains are stationary. Distances and times to be stationary change from locality to locality. The invention checks a variety of prerequisites, including detection distances, determination of zones, and speed limits.

Light Rail Transit Vehicle Crossings: Similar to railroad tracks, many localities have different rules for light rail transit. The rules may differ from the rail rules. The invention has the capability of testing both rail and light rail.

Near Streetcars, Trolleys, or Buses: As with rail and light rail, special rules apply for streetcars, trolleys, or buses. The invention checks if these rules are met.

Business or Residential Districts: Most localities have blanket speed limits for business or residential districts. The invention checks that these rules are met.

Near Animals: Many municipalities have special rules when dealing with animals and livestock. The rules may involve the recognition of the animals or the road signs at distance and it usually requires the vehicle to lower its speed limit. The invention incorporates among its checks that animals are detected by the locality and verifies that these rules are met.

Visual Search: Many localities require that the drivers perform a scan of the surrounding areas, both forwards and backwards, every few seconds. The rules related to scanning usually involve tailgating. For example, many localities require that the distances maintained with other vehicles going in the same direction be at least 4 seconds. If this is a rule of the locality, the invention will check that these rules are met.

Lane Control: As with signs, lane markings indicate to the driver that different rules apply. Understanding these lane markings needs to be performed with sufficient distance to react. The invention will verify that the lane markings are detected with sufficient distance to react and that the specific rules that are embodied by those signs are followed.

Line Colors, which may come in different varieties depending on the locality: Usually, but not exclusively, these include Solid yellow lines, Broken yellow lines, Two solid yellow lines, Solid white lines, Broken white lines, Double white lines. Each of these line types represents a different set of rules governing the passing, or lack of it, rules. The invention verifies that the autonomous system recognizes each of the lines required by the locality, and given that they recognition was performed, that the rule embodied by the sign is followed. For example, the invention will note if the vehicle passes on a double solid yellow.

Choosing a Lane: Most localities have rules referencing preferred passing and non-passing lanes. Usually, the lanes closer to the median are considered passing lanes and should not be occupied if room is available in the outer lanes. The invention will verify that these rules are met.

Changing Lanes: Most localities include rules about lane changes. In general, they include rules forbidding lane changes in intersections and separation distances involving clearances with other vehicles and approaching speeds of other vehicles. The invention verifies that these rules are met and the clearances are maintained.

Passing Lanes: Most localities include rules restricting traffic from passing in the right lane, or leaving the paved roads to pass. Generally, passing on the right is only allowed if the left lane has a turning lane. Some localities allow for passing on the right lane only if the highway has three or more lanes in the same direction while other localities do not. The invention checks if the rules relative to passing lanes are followed.

Carpool/HOV Lanes: Some localities have carpool/HOV lanes. These lanes may only be available at some times of the day, and only for a certain number of passengers onboard. Other rules only allow low emissions vehicle to use certain lanes. In the future, some lanes may be dedicated as human-driver or autonomous-driver lanes. If the application and locale require that the vehicle be aware of the number of passengers, the invention will verify accordingly. Depending on the rules, the vehicle will need to be aware of the time and time zone.

Center Left Turn Lanes: Many roads and localities allow for center turn lanes. There are special rules that apply for these lanes. In particular, most localities do not allow these lanes to become passing lanes, or for vehicles to drive more than a certain distance using that lane without turning. The invention verifies that these rules are met.

Turnout Areas and Lanes: Turnout areas are sometimes marked on two-lane roads to allow faster cars to pass. Several localities require that a slow vehicle being followed by a certain number of vehicles use the turnout lane to allow the faster vehicles behind to pass. This is complicated, as some localities require that the vehicle sense if five or more vehicles be queued behind to trigger. If the locality requires, the invention will check that the self-driving vehicle uses the turnout lanes under the required conditions.

End of Lane Marking: Localities require that vehicles obey the end-of-lane markings. In this case, the invention will check if the vehicles leave the lane with sufficient distance and merge into traffic, following the appropriate separation distances.

Yield Lines: Some localities have Yield Lines or “shark teeth.” These lines indicate to vehicles where they should stop or yield. These lines are commonly used in areas where ambulances, fire trucks, or other emergency response vehicles would enter the roadways. The vehicle must traverse the lines or stop before the lines, but not on the lines. The invention will check if the autonomous system can recognize the lines and that the rules are followed.

Shared Roadway, Bicycle Markings, and Bicycle Lanes: Most localities include special rules related to shared or non-shared bicycle lanes. The autonomous system must recognize if the lanes are present, and populated by bicycles or other allowed vehicles, and follow the corresponding rules. The rules may include specialized speed limits and separation distances between the vehicles and the bicycles. In particular, there are differences if the vehicle encroaches into the bicycle's space, or if the bicycle encroaches into the vehicle's space; the behavior dictated by the locality changes accordingly.

Left and Right Turn: Most localities require that the user turns on the blinkers some distance ahead of the turn. The turns are allowed only in some intersections and sometimes at a certain time. The invention verifies that the blinkers are turned on at the appropriate distance and that the turns are only performed in areas and times allowed.

Public Transit Bus Lane: Many localities have rules related to Public Transit. These lanes may only be allowed to be used at certain times of the day. However, some localities allow vehicles to use the bus lane to make a turn. The invention will verify that the bus lanes are recognized and that the time is used to determine if the maneuver is legal.

Right Turn Against a Red Traffic Signal: Many localities allow for right turns on a red traffic light, while some others do not. The invention will verify that these rules are followed. Just as importantly, vehicles are usually allowed to encroach on the bike lanes for a certain amount of distance before making a right turn. Most localities require that there is a full stop before making a right turn. The invention verifies that these rules are met.

Right Turn onto a Road with a Dedicated Lane: Some localities have dedicated right turns that do not require the vehicles to stop. The invention verifies that the autonomous system stops in the right turn lane where it is required, and does not stop in right turn lanes where it is not required.

Left Turn from a Two-Way Street: Depending on the signals, most localities only allow that the left lane turns left to the furthest left lane, unless marked otherwise. The invention checks if these rules are met and that the signals are recognized.

Left Turn from a One-Way Street onto a Two-Way Street: Most localities require certain separations between the turning vehicle and the incoming traffic. Other localities describe separation in time and not distance, to deal with slow traffic in the road being merged. The invention verifies that these rules are being followed.

Left Turn from a One-Way Street onto a One-Way Street: Most localities require a full stop, though others do not. The invention verifies that these rules are met.

Right Turn from a One-Way Street onto a One-Way Street: Most localities require a stop in addition to the distance and time requirements. The invention verifies that these rules are met.

Turn at a “T” Intersection from a one-way street into a two way street.

Legal U-Turns: Most localities require large separations before allowing a u-turn. Others set timing-based separations. There are also a significant number of rules disallowing u-turns under a variety of conditions: railroad tracks, divided highways, hills, rain, fog, or signs disallowing it. The invention verifies that the vehicle follows these rules.

Parking on a Hill: Many localities require that vehicles parked on a hill point their wheels so that the vehicle would go towards the curb if the brakes were to fail. Some localities also require that the vehicle point towards the curb when parked in a flat area. These rules usually only apply in areas with curbs, and not in a parking lot. The invention verifies that these rules are met.

Parallel Parking: Most localities have strict rules on parallel parking, specifying distances to the curb and between vehicles. The invention will verify that these rules are met.

Parking at Colored Curbs: Curbs are painted in different localities to represent different regulations: White, Green, Yellow, Red, Blue, etc. The localities use these colors to stipulate the amount of time and use of the particular curb related to parking. For example, a red curb usually means that no stopping, standing, or parking is allowed. Other areas may be more permissive. Some areas change the rules depending the time of the day, or even if the vehicle has specialized placards. The invention verifies that these rules are met.

Illegal Parking: Most localities have very strict rules of specifying locations where vehicles cannot be parked. These usually include signed areas, crosswalks, sidewalks, disabled parking areas, zero-emission vehicles, tunnels, bridges, railroads, wrong side of the street, freeways, etc. These rules vary widely between one location and another. The invention checks that those rules are met by the self-driving vehicle.

Turning signals: Most localities have specific rules on when these signals must be applied. Some localities require that vehicles use the turning or hazards signals while stopping or slowing down. Most localities require that the turning signals be used when attempting to park, or when changing lanes. The rules change depending on if the areas are streets or highways. For example, on the highway, there may be a requirement that the signals are turned on five seconds before changing lanes; in a city street, the rules may stipulate a distance. The invention verifies that the local rules are met.

Following Distances: Most localities specify a following distance requirement. These requirements change depending on a variety of conditions: road type, weather, vehicle type, etc. The invention verifies that the local rules are met.

Space to Merge: Most localities specify a required space to merge so as not to encroach on other vehicles. This space is often provided as distance or time. The invention verifies that the local rules are met.

Space to Cross or Enter: Most localities specify a required space to cross or enter so as not to encroach on other vehicles. This space is often provided as distance or time. The invention verifies that the local rules are met.

Space to Exit: Most localities specify a required space to exit so as not to encroach on other vehicles. This space is often provided as distance or time. The invention verifies that the local rules are met.

Lights: Most localities require that the vehicles turn on their light from dusk to dawn and when it is cloudy, raining, or foggy. Some other localities require that the lights are on all of the time. Emergency lights must be turned on if the vehicle is having problems and cannot meet the traffic speed. The invention verifies that the local rules are met.

Wipers: Most localities require that the wiper be turned on in the case of rain. The invention verifies that the local rules are met.

Horn: The rules controlling the use of the horn vary widely with the locality. Most areas require that the horn be used in the case of an impending collision, or in narrow mountain roads that do not allow to see more than a certain distance. The invention verifies that the local rules are met.

Emergency Vehicles: Most municipalities have special rules for Emergency vehicles. Some of the rules involve separation distances. For example, California requires a 300 ft separation behind a fire engine, police vehicle, ambulance, or other emergency vehicle that has flashing sirens. These rules require that the self-driving vehicle detects the flashing sirens, and the fact that they are coming from an emergency vehicle. The invention verifies that the local rules are met.

Motorcycles: Most localities include special rules for motorcycles, including separation distances. This requires that the vehicles recognize that the object is a motorcycle, as opposed to other traffic, and that the separation distances are maintained. The invention verifies that the local rules are met.

Bicycles: As with motorcycles, most localities include rules that are specific to bicycles and require the traffic to distinguish bicycles from other modes of transportation. The “following” and “separation” distances are usually different between bicycles and motorcycles. In order to follow these rules, the vehicles usually must be able to categorize the differences between the two, or follow more restrictive rules. The invention verifies that the local rules are met.

Blind pedestrians: Some localities have different rules for pedestrians that are blind. These rules usually provide right-of-way to these special pedestrians no matter where they are. This creates yet a new category for which the rules are different. The invention verifies that the local rules are met.

Road Workers and Work Zones: Most localities have special signs used for directing traffic during road repair. The signs may include stop, slow, go, and different speed limits. Sometimes these signs are posted, and sometimes they are carried by road workers. If the locality requires that self-driving vehicles must detect these signs, the invention will verify that the rules are being met.

Driving During Hazards: Most localities change the speed rules depending on weather conditions. For example, some localities specify that if the road is wet, traffic should drive 10 mph under the speed limit, and 5 mph for ice. If the self-driving vehicles drive in areas where these rules are enforced, the vehicle must be able to recognize these conditions and follow the rules. The invention verifies that the local rules are met.

Special Locale Rules: Some locales have specific rules to protect flora or fauna of the locale. For example, Australia has specific rules related to driving next to Koala bears. These rules may require the vehicle to detect and classify some animals or conditions that are not required in other locales. The invention verifies that the local rules are met.

The rules of the locales that the vehicle will operate in can be broken down into more fundamental sensing and control parameters. In other words, although the number of rules of the locale is large, they can be mapped into a relatively small number of fundamental skills that embody the vehicle's capabilities. Measuring these skills as they apply to the rules allows one to determine the vehicle's safety in a simpler and more consistent manner.

All rules require that the vehicle sense or classify a feature or object and act accordingly. For example, a rule that says that the vehicle must maintain a separation distance of 300 ft, on the highway, to the vehicle in front, can be simplified as: the vehicle knows that it is on a highway with 65 mph speed limit, the vehicle can sense and classify that there is a vehicle in its lane at 300 feet, the vehicle can measure the distance to that vehicle, and the vehicle can control its throttle and brakes to maintain the required separation.

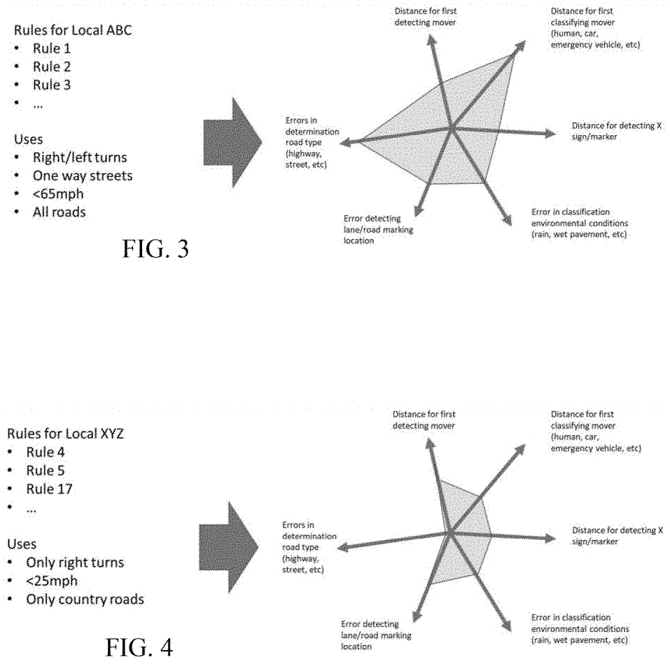

Other rules decompose in very similar ways creating a relatively small set of skills that need to be mastered. The ability to which the vehicle masters these skills is relatively easy to quantify. The illustrations of FIGS. 3 and 4 show how two different applications in two different locales map differently to the same skills. The rules and uses that are being mapped to a few dimensions in exemplary spider graphs include: how far a moving object was detected and classified from the vehicle, how far static obstacles were detected and classified from the vehicle, how far away signs on the road were detected, how far away markings on the road detected, any errors in lane detection, any errors in the location of the detected static and moving obstacles, any errors in prediction of moving object location, etc.

The list and number of dimension of these graphs will be different depending on the rules of the locale and the applications being used, however, the number of dimensions is minimized to reduce the number of measurements that need to be performed by the safety assessment. The skills may also be partitioned depending on the directionality. For example, the system may be asked to measure how far a moving object is detected in the forward direction separately from the backward direction, as the rules that apply for reversing may be different.

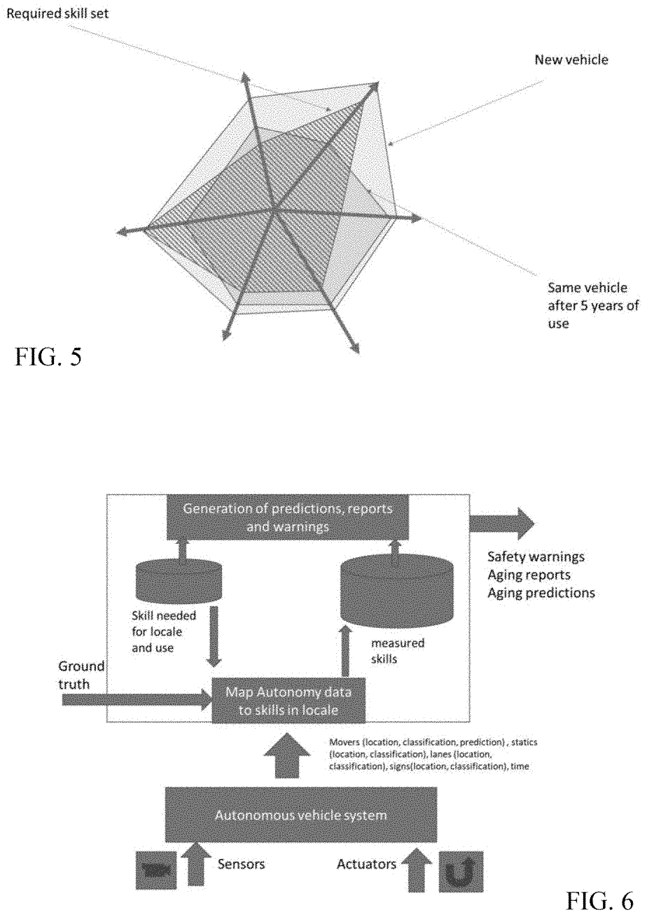

FIG. 5 illustrates an function map analyzing a self-driving vehicle over time. As the vehicle ages, the ability to perform the skills will affect their spider graph, and at some point, the skill will no longer be able to meet the requirements of the rule-set required by the combination of locale and application. If the mapping of rules to skills is correct and the assessment of the skills is correct, the system should be able to accurately determine if a particular vehicle is safe for a particular application in a locale. Such information may be presented in any form, such as Venn diagrams, neural networks, and other representations.

The skills of a self-driving vehicle can be measured without the need for the vehicle to break rules or endanger the environment. The skills for detection and classification can be evaluated, in most cases, even if the vehicle is not in motion. For example, how far a vehicle detects a pedestrian in the roadway in front can be measured and recorded, even if the car is backing up. In other words, the skills that have been determined to be needed for the locale and application can be measured at all times, even if the vehicle is stopped or driven by a human.

The skills can be assessed real-time or post-processed. In both cases, the assessment can be performed by comparing data provided by the vehicle against ground truth or against data provided by the vehicle at different times. For example, a self-driving vehicle may provide information that there is a pedestrian 120 m away, and then at 110 m it reports that the pedestrian is a dog, and then at 100 m a bicycle, all the way until it is a few meters away. Even though the autonomous system may not have ground truth of what the object is it knows that the same item had different classifications over time. Because the classification is significantly harder at distances and becomes easier at shorter ranges, the invention may determine with high probability that the item was really a bicycle, and determine if the needed skill of detecting, classifying, or localizing bicycles is based on that measurement at 100 m. As the vehicle is provided more data, the invention will continue the assessment of that particular skill. Of course, if ground truth is available, and the item is a bicycle and not a pedestrian, then the problem is significantly easier to assess.

The historical patterns of the particular skill can be used to predict future capabilities, and even to trigger sensor upgrades or re-calibration. For example, if the vehicle's ability to determine the position and classification of a pedestrian is measured at 100 m when new, and it becomes 60 m after one year of operation, and the minimum requirements for the locale and application is 50 m, the vehicle manufacturer may determine that it is necessary to replace, recalibrate, or retire the subcomponents related to that particular skill even before rules are broken.

FIG. 6 schematically presents a system and method for verifying that a self-driving vehicle follows traffic ordinances, as contemplated by the present invention. The invention receives information from the autonomous system. This information includes items detected by the autonomous system, such as information about the detected static and moving obstacles, signs, lanes, weather, and road conditions. The location of these items and their prediction on how the autonomous system believes that they are going to move is time tagged. The invention then compares the sensed information against ground truth of those items. Ground truth is either provided externally or it is deduced from historical data provided at shorter distances. The comparisons produce measurements of skills that are necessary for driving safely in that locale. The performance of the vehicle for each skill is then used to determine the safety of the vehicle and to generated predictions, warnings, and reports. These reports can be used by an official to determine the suitability of the vehicle for an application or use. The reports can be used to set up maintenance schedules, or by insurance companies to determine the rates to charge the owner of the vehicle.

In various embodiments the system and method determines various skills from the rules of the road for that locale and use. The information sent from the self-driving vehicle includes: information about moving features, information about static features, information about lanes, information about weather conditions, information about road conditions, and/or information about vehicle states. A module may use a predictor (Kalman filter, neural network, etc.) to determine the future performance for each skill and/or the predicted dates at which the skills will no longer meet the skill set necessary to follow the rules of the road, in that locale, under that use. The reports show not only the current vehicle skill set, but the historical trends of each skill set. The reports are used as a warning, or they forcefully disable/geo-fence the vehicle from operating in areas where the rules cannot be met given the current skill set. Reports may state which rules could be broken given the current vehicle's skill set. The skills measured include one or more of the following: first detection of dynamic obstacle; first detection of static obstacle; first correct classification of mover; first classification of static; first detection of sign; first detection of road marking; accuracy of prediction; accuracy of classification; accuracy of detection of road condition; accuracy of detection/classification/prediction of mover; accuracy of longitudinal vehicle control; accuracy of side-to-side vehicle control; accuracy stopping at desired location; accuracy of prediction of movers; accuracy of classification of emergency vehicles; accuracy of classification of motorcycles; accuracy of classification of bicycles; accuracy of classification of animals and livestock; accuracy of absolute vehicle localization.

The ground truth is extracted by post-processing the information of future detections or externally provided. Separate databases are used to collect information about multiple skill sets needed by different locality or uses. The reports try to predict how often a particular rule will be broken given information that has been collected in the locale. A human drives the autonomous vehicle, or the sensor suite is driven by other means such as teleoperation. The information from the self-driving vehicle autonomous system is stored in its raw format as well as mapped to each skill. The raw detection data is “re-mapped” to a new skill set to verify the safety of a different locale or a different use. The skill used are the actual rules of the road for the locality rather than abstractions. The self-driving vehicle autonomous system is not connected to the actuators of the vehicle, the vehicle is being driven with a human driver, however, all detections and predictions of the self-driving vehicle autonomous system are recorded to measure the skills and therefore safety. The system will automatically determine the set of rules and uses that the vehicle is capable of following given a particular skill set of data collected. For example, given data collected over a set amount of time in a locale, the use would like to know if the vehicle could function at 55 mpth rather than 50mph, or if the vehicle is safe for a particular locale.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An autonomous vehicle safety assessment system, comprising:
a vehicle;
an autonomous vehicle system;
a communication protocol;
a vehicle-specific database; and
a reporting module;
wherein said autonomous vehicle system comprises a plurality of sensors and a plurality of actuators;
wherein said autonomous vehicle system is installed in said vehicle;
wherein said communication protocol is installed in said vehicle; and
wherein said communication protocol connects said autonomous vehicle system to the autonomous vehicle safety assessment system such that a plurality of vehicle performance data is reported from said vehicle.

2. The invention of claim 1, further comprising:
a ground truth;
wherein said ground truth comprises a plurality of object data in a specific locale; and
wherein said ground truth comprises a plurality of rules of the road in a specific locale.

3. The invention of claim 2,
wherein said plurality of vehicle performance data further comprises an acceleration data, a steering data, and a braking data.

4. The invention of claim 3,
wherein said plurality of vehicle performance data further comprises a plurality of sensor data.

5. The invention of claim 4,
wherein said vehicle is subject to a vehicle performance test in said specific locale;
wherein said specific locale comprises a plurality of road traffic rules; and
wherein said plurality of sensors report a plurality of sensor readings and said plurality of actuators report a plurality of actuator readings to said communication protocol; and
wherein said communication protocol processes said plurality of sensor readings and said plurality of actuator readings to create a plurality of objective measurements.

6. The invention of claim 5,
wherein said vehicle is analyzed for compliance with said plurality of road traffic rules by assessing said plurality of objective measurements against a plurality of expected performance standards by said communication protocol.

7. The invention of claim 6,
wherein said assessment of said plurality of objective measurements against said plurality of expected performance standards by said communication protocol is associated with a date stamp.

8. The invention of claim 7,
wherein said assessment of said plurality of objective measurements against said plurality of expected performance standards by said communication protocol associated with said date stamp is stored in said vehicle-specific database.

9. The invention of claim 8,
wherein said reporting module creates a vehicle report from said assessment of said plurality of objective measurements against said plurality of expected performance standards by said communication protocol associated with said date stamp.

10. The invention of claim 9,
wherein said vehicle report may be presented as a visual report graph.

11. The invention of claim 10,
wherein said vehicle report and said visual report graph are stored in said vehicle-specific database.

12. The invention of claim 11,
wherein said vehicle report triggers a plurality of vehicle alerts.

13. The invention of claim 12,
wherein said vehicle report triggers a geofencing of said vehicle.

14. The invention of claim 13,
wherein said vehicle report creates an aging report; and
wherein said vehicle report creates an aging prediction.

15. The invention of claim 14,
wherein said objective measurements comprise a first detection of dynamic obstacles, a first detection of static obstacles, a first correct classification of moving objects, a first correct classification of static objects, a first detection of signs, a first detection of road markings, an; accuracy of predictions, an accuracy of classifications, an accuracy of detection of road conditions, an accuracy of longitudinal vehicle control, an accuracy of lateral vehicle control, an accuracy stopping at a desired location, an accuracy of prediction of moving objects, an accuracy of classification of emergency vehicles, an accuracy of classification of motorcycles, an accuracy of classification of bicycles, an accuracy of classification of animals, and an accuracy of absolute vehicle localization.

16. The invention of claim 15,
wherein said objective measurements are compared to said plurality of expected performance standards for a second locale.

17. A method for autonomous vehicle safety assessment, comprising:
testing a vehicle around a specific locale;
capturing a plurality of vehicle performance data;
capturing a plurality of sensor readings;
capturing a plurality of actuator readings;
sending said plurality of vehicle performance data, said plurality of sensor readings, and said plurality of actuator readings to a communication protocol;
comparing said plurality of vehicle performance data, said plurality of sensor readings, and said plurality of actuator readings to a plurality of expected performance standards.

18. The method of claim 17, further comprising:
storing said comparison of said plurality of vehicle performance data, said plurality of sensor readings, and said plurality of actuator readings to a plurality of expected performance standards in said vehicle-specific database with a date stamp as a vehicle report;
creating a visual report graph from said vehicle report.

19. The method of claim 18, further comprising:
comparing said vehicle report with a previous vehicle report.

20. The method of claim 19, further comprising:
triggering a plurality of vehicle alerts.
